(19) United States
(12) Patent Application Publication
(10) Pub. No.: US 2019/0065502 A1
(43) Pub. Date: Feb. 28, 2019

(54) PROVIDING INFORMATION RELATED TO A TABLE OF A DOCUMENT IN RESPONSE TO A SEARCH QUERY

(71) Applicant: Google Inc., Mountain View, CA (US)

(72) Inventors: Hongrae Lee, Mountain View, CA (US); Jayant Madhavan, San Francisco, CA (US); Yuliang Li, La Jolla, CA (US)

(21) Appl. No.: 14/692,164

(22) Filed: Apr. 21, 2015

Related U.S. Application Data
(60) Provisional application No. 62/036,956, filed on Aug. 13, 2014.

(51) Int. Cl. G06F 17/30

(52) U.S. Cl. CPC G06F 17/3053; G06F 17/30554; G06F 17/30864; G06F 17/30011

(57) ABSTRACT

Methods and apparatus determining features related to a table of a document and/or providing information related to a table of a document in response to a search query. Some implementations are directed generally to determining an ordered collection of information that is responsive to search query terms, wherein the ordered collection of information is based at least in part on content of a table of a document that is responsive to the search query terms. Some implementations are directed generally to determining a table of a document includes an ordered collection of information and determining one or more features of the table.

### BACKGROUND

Search engines provide information about accessible documents such as web pages, images, text documents, and/or multimedia content. A search engine may identify the documents in response to a user's search query that includes one or more search terms. The search engine ranks the documents based on the relevance of the documents to the query and the importance of the documents and provides search results that include aspects of and/or links to the identified documents.

### SUMMARY

This specification is directed generally to determining features related to a table of a document and/or providing information related to a table of a document in response to a search query. Some implementations are directed generally to determining an ordered collection of information that is responsive to search query terms, wherein the ordered collection of information is based at least in part on content of a table of a document that is responsive to the search query terms. The ordered collection of information may be provided in response to a search query that includes the one or more search query terms. For example, the ordered collection of information may be a list of the countries with the highest populations (optionally including indications of the populations) and may be provided in response to a superlative search query of “country with most population.” The ordered collection of information may be based on content of a table of a document (e.g., a webpage) that is responsive to the search query. Techniques described herein may be utilized to determine that the ordered collection of information is responsive to the search query and should be provided in response to the search query.

Some implementations are directed generally to determining a table of a document (e.g., a webpage) includes an ordered collection of information and determining one or more features of the table. In some implementations, the features may include one or more of a subject of the table, an attribute of the table, a modifier of the table, and/or a superlative of the table. The features may be determined based on content of the table itself and/or additional content external to the content of the table itself. The features may be utilized to determine if content of the table is responsive to a search query and/or to determine a degree of relevance of the content to the search query.

In some implementations, a computer implemented method may be provided that includes the steps of: identifying one or more search query terms; identifying one or more documents responsive to the search query terms; determining an ordered collection of information that is responsive to the search query terms based at least in part on association of the ordered collection of information with a given document of the documents, wherein the ordered collection of information is based on content of a table of the given document; and providing the ordered collection of information in response to a search query including the one or more search query terms.

This method and other implementations of technology disclosed herein may each optionally include one or more of the following features.

In some implementations, the method may further include ranking the documents, wherein determining the ordered collection of information that is responsive to the search query terms includes determining the ordered collection of information based at least in part on the ranking of the given document. In some of those implementations, the method may further include determining, based on the search query terms, a relevance score associated with the ordered collection of information; wherein determining the ordered collection of information includes determining the ordered collection of information based at least in part on the relevance score.

In some implementations, the method may further include identifying a term of one or more of the search query terms; wherein determining the ordered collection of information includes matching the term to a superlative associated with the ordered collection of information, the superlative indicating a type of ranking of the table.

In some implementations, the method may further include identifying a term of the one or more of the search query terms; wherein determining the ordered collection of information includes matching the term to a subject associated with the ordered collection of information, the subject indicating an entity type of the table.

In some implementations, the method may further include determining a relevance score for the ordered collection of information based on: a relationship between one or more of the search query terms and a subject associated with the ordered collection of information, the subject indicating an entity type of the table; and a relationship between of one or more of the search query terms and an attribute associated with the ordered collection of information, the attribute indicating a measure by which the subject is ranked in the table; wherein determining the ordered collection of information includes determining the ordered collection of information based at least in part on the relevance score of the ordered collection of information.

In some implementations, the table of the given document includes a plurality of columns and determining the ordered collection of information includes selecting the content of only a subset of the columns for inclusion in the ordered collection of information.

In some implementations, the table of the given document includes a plurality of rows in an order and determining the ordered collection of information includes at least one of: selecting the content of only a subset of the rows for inclusion in the ordered collection of information; and changing the order of the content of one or more of the rows in the ordered collection of information. In some of those implementations, the method further includes: identifying a modifier of a subject based on one or more of the search query terms, the modifier indicating a constraint on the subject; wherein determining the ordered collection of information includes selecting the content of only the subset of the rows based on the modifier.

In some implementations determining the ordered collection of information includes: accessing a table information index that includes a plurality of entries; and identifying the ordered collection of information based on a document identifier of a given entry of the entries, the document identifier identifying the given document. In some of those implementations, determining the ordered collection of information further includes: matching one or more of the search query terms to table features included in the given entry, the table features associated with the table of the given document. In some of those implementations, determining the ordered collection of information further includes: accessing the given document; and determining the ordered collection of information based at least in part on the content of the table of the given document. In some of those implementations, determining the ordered collection of information further includes identifying the ordered collection of information based at least in part on information included in or associated with the given entry, the information previously determined based at least in part on the content of the table of the given document.

In some implementations, the method further includes receiving the search query from a client device, wherein identifying the search query terms includes identifying the search query terms from the search query; wherein providing the ordered collection of information in response to the search query includes providing the ordered collection of information to the client device. In some of those implementations, the method further includes identifying the search query is a superlative query; wherein determining the ordered collection of information is based on identifying the search query is a superlative query. In some of those implementations, the method further includes: ranking the documents; determining a search result set for a set of the documents based on the ranking; and providing the search result set in combination with the ordered collection of information in response to the search query.

In some implementations, providing the ordered collection of information includes ordering the ordered collection of information as it is ordered in the table of the given document.

In some implementations, providing the ordered collection of information includes formatting the ordered collection of information as it is formatted in the table of the given document.

In some implementations, a computer implemented method may be provided that includes the steps of: identifying content of a table in an electronic document; determining the table includes an ordered listing based on the content; determining at least one subject of the table, the subject indicating an entity type of entities of the table; determining at least one attribute of the table, the attribute indicating a measure by which the entities are sorted or ranked in the table; associating the subject and the attribute with an identifier of the document; and indicating the document includes a table with an ordered collection.

This method and other implementations of technology disclosed herein may each optionally include one or more of the following features.

In some implementations, determining at least one of the subject and the attribute is based on additional content that is external to the content of the table. In some of those implementations, the additional content includes content of the electronic document. In some implementations, the additional content includes a title of the electronic document.

In some implementations, the method further includes: identifying a plurality of queries to which the electronic document is responsive; and identifying the additional content based on one or more of the queries.

In some implementations, the method further includes: identifying a plurality of previous queries of users, each of the previous queries associated with at least a threshold level of selection of the electronic document in response to the query; and identifying the additional content based on one or more of the past queries.

In some implementations, the method further includes: receiving a search query including search query terms; identifying the document is responsive to the search query; identifying, based on the document being responsive to the search query, the subject and the attribute based on the association of the identifier of the document to the subject and the attribute; matching one or more of the search query terms to one or more of the subject and the attribute; determining, based on the matching, an ordered collection of information that reflects at least some of the content of the table; and providing the ordered collection of information in response to the search query. In some of those implementations, the method further includes: determining a relevance score associated with the ordered collection of information based on comparing of one or more of the search query terms to one or more of the subject and the attribute; and providing the ordered collection of information in response to the search query based at least in part on the relevance score satisfying a threshold.

In some implementations, indicating the document includes a table with an ordered collection of information includes storing the subject and the attribute, and the association to the identifier in a table information database.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which features related to a table of a document may be determined and/or information related to a table of a document may be provided in response to a search query.

FIG. 2 illustrates a table information engine of FIG. 1 in additional detail and also illustrates some of the components of FIG. 1 that may be in communication with the table information engine.

FIG. 3 illustrates example entries of a table information database of FIGS. 1 and 2.

FIG. 4 illustrates a representation of an example webpage document that has a table that includes an ordered collection.

FIG. 5 is a flow chart illustrating an example method of determining a table of a document includes an ordered collection of information and determining one or more features of the table.

FIG. 6 illustrates a table ranking engine of FIG. 1 in additional detail and also illustrates some of the components of FIG. 1 that may be in communication with the table ranking engine.

FIG. 7A illustrates an example graphical user interface for displaying an ordered collection of information and other search results in response to a query.

FIG. 7B illustrates another example graphical user interface for displaying an ordered collection of information and other search results in response to a query.

FIG. 8 is a flow chart illustrating an example method of determining an ordered collection of information that is responsive to search query terms, wherein the ordered collection of information is based at least in part on content of a table of a document that is responsive to the search query terms.

FIG. 9 illustrates an example architecture of a computer system.

### DETAILED DESCRIPTION

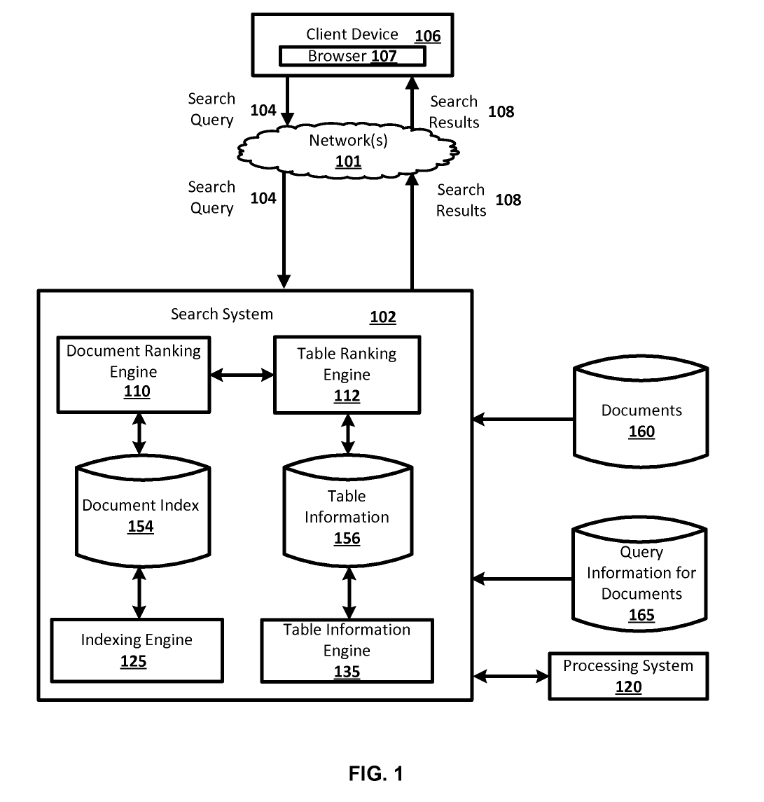

FIG. 1 illustrates an example environment in which features related to a table of a document may be determined and/or information related to a table of a document may be provided in response to a search query. The example environment includes a search system 102, a client device 106, a processing system 120, a documents database 160 and a query information for documents database 165. The search system 102 is an example of an information retrieval system in which the systems, components, and techniques described herein may be implemented and/or with which systems, components, and techniques described herein may interface. As described herein, one or more components of the search system 102 may be provided separate from the search system 102 in some implementations. For example, in some implementations table ranking engine 112, table information database 156, and/or table information engine 135 may be provided in a system that is separate from the search system 102.

A user may interact with the search system 102 via the client device 106. The search system 102 receives search queries 104 from the client device 106 and returns search results 108 to the client device 106 in response to the search queries 104. In some implementations, the search queries 104 may be processed by processing system 120 and the processing system 120 may provide a processed query to the search system 102. In some implementations, the processing system 120 may be configured to rewrite a segment of text such as a received search query 104 (e.g., based on one or more query rewriting rules), annotate one or more types of grammatical information for one or more terms of the segment of text (e.g., annotate parts of speech of the terms, syntactic relationships between the terms, synonyms of the terms, entity identifiers of the terms), and/or annotate other types of information for terms of segment of text (e.g., annotate a likelihood of a term of the segment being a table subject and/or table attribute). The processed query may reflect one or more of the annotations provided by the processing system 120. Additional description of the processing system 120 is provided herein.

Each search query 104 is a request for information. The search query 104 can be, for example, in a text form and/or in other forms such as, for example, audio form and/or image form. Other computer devices may submit search queries to the search system 102 such as additional client devices and/or one or more servers implementing a service for a website that has partnered with the provider of the search system 102. For brevity, however, the examples are described in the context of the client device 106.

The client device 106 may be a computer coupled to the search system 102 through one or more networks 101 such as a local area network (LAN) or wide area network (WAN) (e.g., the Internet). The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. The client device 106 typically includes one or more applications to facilitate submission of search queries and the sending and receiving of data over a network. For example, the client device 106 may execute one or more applications, such as a browser 107, that allow users to formulate and submit queries to the search system 102.

The search system 102 includes an indexing engine 125 and a document ranking engine 110. The indexing engine 125 maintains a document index 154 for use by the search system 102. The indexing engine 125 processes documents and updates index entries in the document index 154, for example, using conventional and/or other indexing techniques. For example, the indexing engine 125 may crawl one or more resources such as the World Wide Web and index documents accessed via such crawling. Also, for example, the indexing engine 125 may receive information related to one or more documents from one or more resources such as web masters controlling such documents and index the documents based on such information. A document, as used herein, is any Internet accessible document that is associated with a document identifier such as, but not limited to, a uniform resource locator (“URL”), and that includes content to enable presentation of the document via browser 107 and/or other application executable on the client device 106. Documents include web pages, word processing documents, portable document format (“PDF”) documents, to name just a few. Each document may include content such as, for example: text, images, videos, sounds, embedded information (e.g., meta information and/or hyperlinks); and/or embedded instructions (e.g., ECMAScript implementations such as JavaScript). A table of a document includes two or more elements with a structured relationship in the document. As one example, a document may be a webpage and the table of the document may include multiple rows and columns with a structured relationship defined via a markup language of the document.

The document ranking engine 110 uses the document index 154 to identify documents responsive to the search query 104, for example, using conventional and/or other information retrieval techniques. The document ranking engine 110 calculates scores for the documents identified as responsive to the search query 104, for example, using one or more ranking signals.

In some implementations, ranking signals used by document ranking engine 110 may include information about the search query 104 itself such as, for example, the terms of the query, an identifier of the user who submitted the query, and/or a categorization of the user who submitted the query (e.g., the geographic location from where the query was submitted, the language of the user who submitted the query, and/or a type of the client device 106 used to submit the query (e.g., mobile device, laptop, desktop)). For example, ranking signals may include information about the terms of the search query 104 such as, for example, the locations where a query term appears in the title, body, and text of anchors in a document, how a term is used in the document (e.g., in the title of the document, in the body of the document, or in a link in the document), the term frequency (i.e., the number of times the term appears in a corpus of documents in the same language as the query divided by the total number of terms in the corpus), and/or the document frequency (i.e., the number of documents in a corpus of documents that contain the query term divided by the total number of documents in the corpus).

Also, for example, ranking signals used by document ranking engine 110 may additionally and/or alternatively include information about the document such as, for example, a measure of the quality of the document, a measure of the popularity of the document, the URL of the document, the geographic location where the document is hosted, when the search system 102 first added the document to the index 154, the language of the document, the length of the title of the document, and/or the length of the text of source anchors for links pointing to the document.

The document ranking engine 110 ranks the responsive documents using the scores. The search system 102 uses the responsive documents ranked by the document ranking engine 110 to generate all or portions of search results 108. For example, the search results 108 based on the responsive documents can include a title of a respective of the documents, a link to a respective of the documents, and/or a summary of content from a respective of the documents that is responsive to the search query 104. For example, the summary of content may include a particular “snippet” or section of a document that is responsive to the search query 104.

The search system 102 also includes a table ranking engine 112 and a table information engine 135. The table information engine 135 maintains a table information database 156 for use by the table ranking engine 112 and/or otherwise provides information to the table ranking engine 112. Generally, the table information database 156 includes information related to tables of documents, such as documents accessible via documents database 160. For example, the documents database 160 may include a collection of databases accessible via the Internet such as databases typically crawled by the indexing engine 125. For each table, the table information database 156 may include information related to one or more features of the table, an identifier of the document in which the table is provided, and/or other content of the table. In some implementations, the table information database 156 is an index including a plurality of entries, with each of the entries including one or more features of a table (e.g., features related to a subject, attribute, modifier, and/or superlative of the table as described herein) and an identifier of a document in which the table is provided. In some implementations, the table information database 156 may optionally be included in the document index 154. For example, an identifier of a document in the document index 154 may be associated with information indicating features of a table that is present in the document. Certain examples provided herein describe the table information engine 135 determining information related to one or more tables (e.g., features) and storing the information in table information database 156 for use by the table ranking engine 112. In some implementations, the table information engine 135 may determine some or all of such information and provide the information to table ranking engine 112 without storing such information in table information database 156. For example, in some implementations table information database 156 may be omitted and the table ranking engine 112 may utilize information provided by the table information engine 135 and not utilize any information from the table information database 156.

In this specification, the term “database” will be used broadly to refer to any collection of data. The data of the database does not need to be structured in any particular way, or structured at all, and it can be stored on storage devices in one or more locations. Thus, for example, the database may include multiple collections of data, each of which may be organized and accessed differently. Also, in this specification, the term “entry” will be used broadly to refer to any mapping of a plurality of associated information items. A single entry need not be present in a single storage device and may include pointers or other indications of information items that may be present on other storage devices. For example, an entry may include multiple nodes mapped to one another, with each node including an identifier of an entity or other information item that may be present in another data structure and/or another storage medium.

Generally, the table information engine 135 processes documents to determine tables of the documents that include an ordered collection and to determine one or more features for those tables. For each table with an ordered collection, the table information engine 135 populates the table information database 156 with information related to one or more features of the table, an identifier of the document in which the table is provided, and/or other content of the table. The table features may be determined based on content of the table itself and/or additional content external to the content of the table itself.

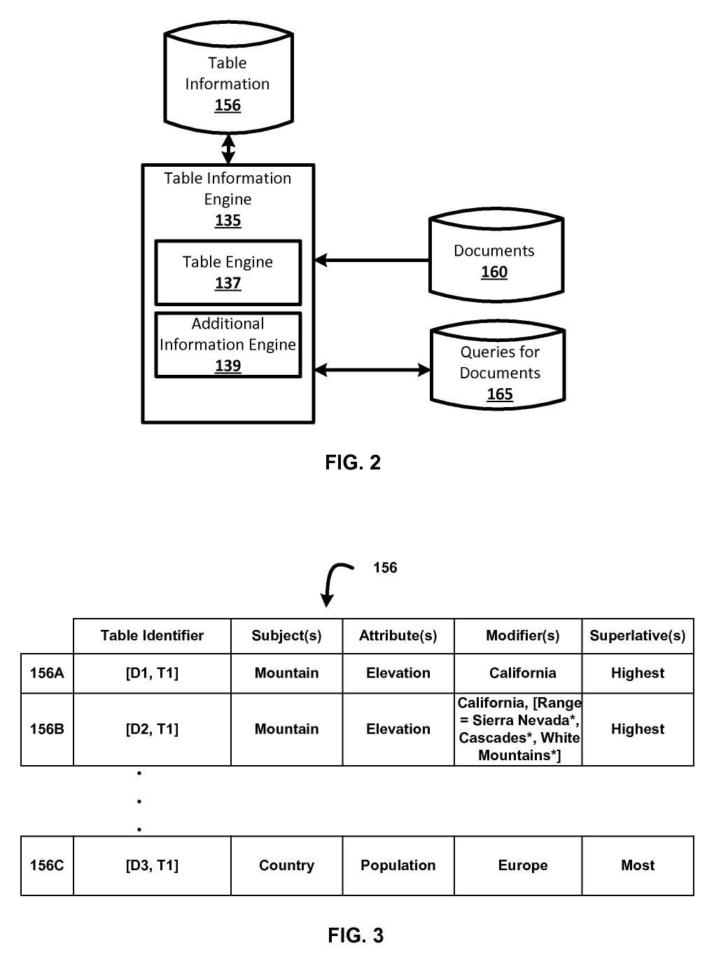

In some implementations, the table information engine 135 may optionally be included in the indexing engine 125. For example, one or more methods performed by the table information engine 135 may be performed by the indexing engine 125 when the indexing engine 125 crawls one or more resources (e.g., documents database 160) to update the document index 154. Additional description of the table information engine 135 and the table information database 156 is provided herein (e.g., in the below description of FIGS. 2-5).

Generally, the table ranking engine 112 may utilize information from the table information database 156 to select one or more tables that are responsive to the search query 104, for example, based on matching of the search query 104 to one or more features of the tables in database 156 and/or based on other techniques such as those described herein. As described herein, matching of the search query 104 may optionally include processing the search query 104 and using one or more annotations of the processed query in the matching. In some implementations, the table ranking engine 112 may determine if the search query 104 is a superlative query and only select one or more tables if the search query 104 is a superlative query. In some implementations, the table ranking engine 112 may only select one or more tables if the search query 104 meets one or more additional and/or alternative criteria. For instance, the table ranking engine 112 may not select tables for queries that include certain terms, more than a threshold number of terms, etc. The table ranking engine 112 may optionally calculate relevance scores for the tables identified as responsive to the search query 104, for example, using one or more ranking signals. The table ranking engine 112 may use the scores, for example, to select one or more tables from a larger group of candidate tables. As described herein, the ranking signals for a given table may be based on one or more of a ranking of the document in which the given table is provided (e.g., as determined by document ranking engine 110), information related to one or more relationships between the terms of the search query 104 and one or more features of the given table, and/or information related to one or more relationships between the terms of the search query 104 and one or more other queries to which the document in which the given table is provided is responsive (e.g., previously submitted superlative queries).

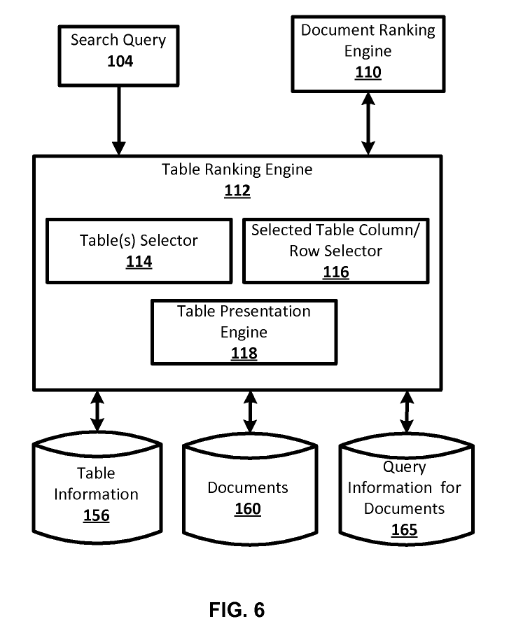

The table ranking engine 112 and/or the table information engine 135 determines an ordered collection of information based on content of the selected one or more tables that are responsive to the search query 104. For example, the table ranking engine 112 may extract content of a table from the document in which the table is provided and utilize the content to determine the ordered collection of information. For instance, content from one or more rows and/or columns of the table may be utilized as the ordered collection of information. Also, for example, the table information database 156 may include information related to previously extracted content of a table and the table ranking engine 112 may utilize such information to determine the ordered collection of information. For instance, for a given table, the table information database 156 may include content from one or more rows and/or columns of the table and such content may be utilized to determine the ordered collection of information. Additional description of the table ranking engine 112 is provided herein (e.g., in the below description of FIGS. 6-8).

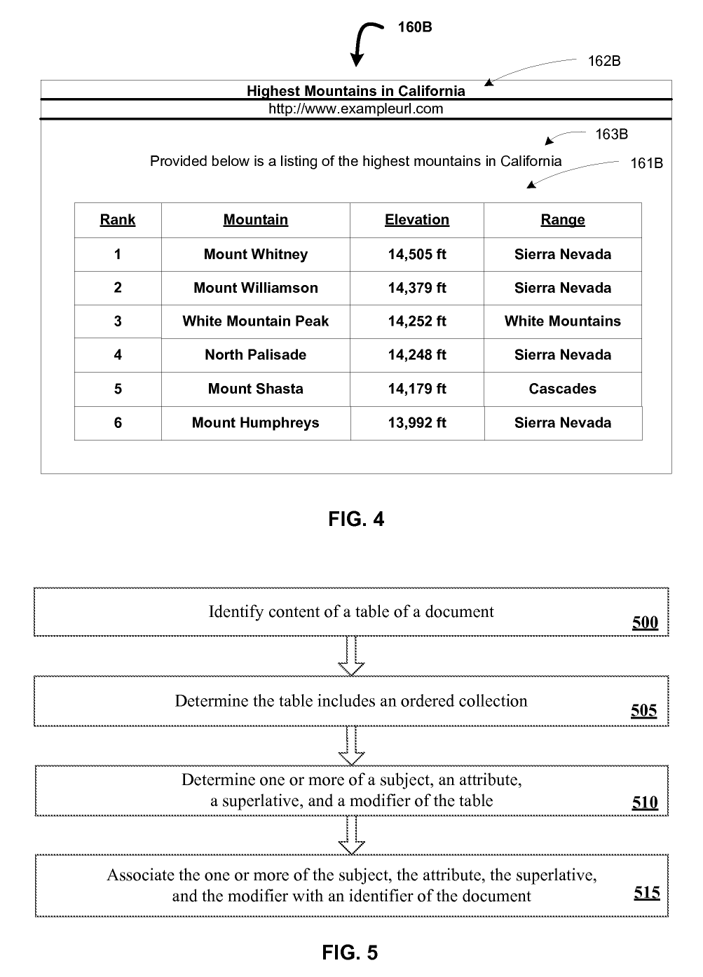

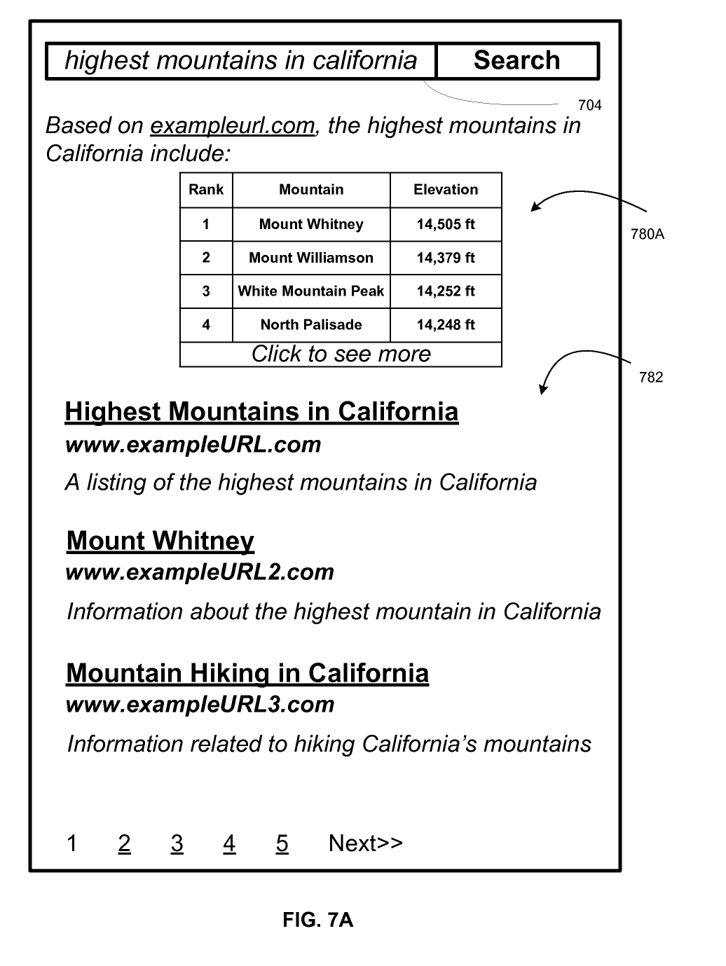

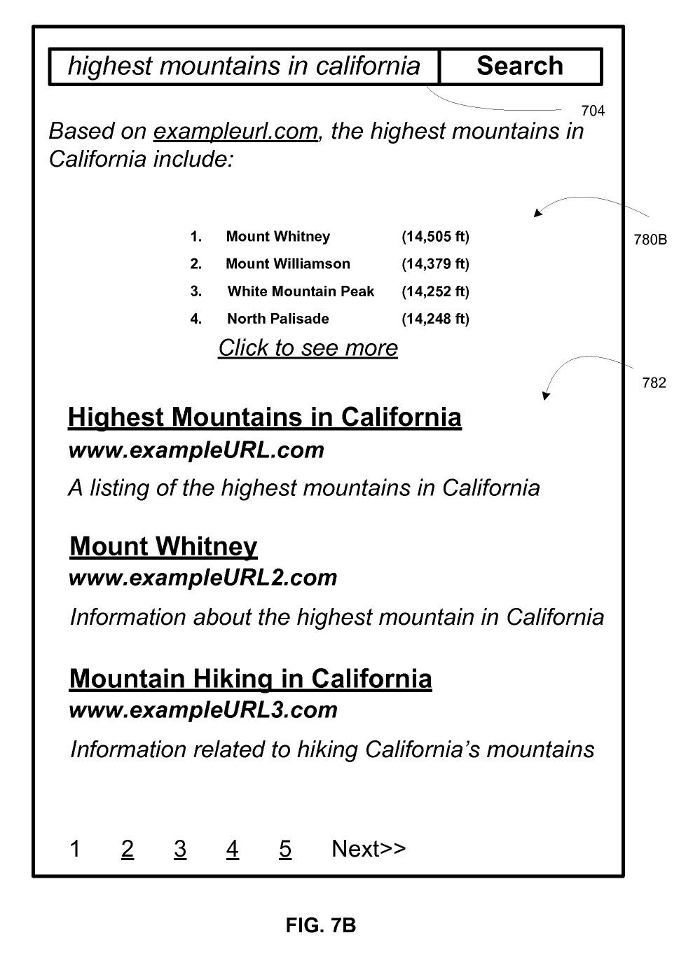

The search system 102 includes the ordered collection of information determined by the table ranking engine 112 as all or a portion of search results 108. For example, the search results 108 may include only the ordered collection of information or may include the ordered collection of information in combination with one or more search results based on the responsive documents identified by the document ranking engine 110. For example, the search results illustrated in FIG. 7A in response to search query 704 include an ordered collection of information 780A in combination with search results 782 that are based on the responsive documents identified by the document ranking engine 110. Likewise, the search results illustrated in FIG. 7B in response to search query 704 include an ordered collection of information 780B in combination with the search results 782. The collections of information 780A and 780B may be based on the table 161B of FIG. 4.

The search results 108 are transmitted to the client device 106 in a form that may be presented to the user. For example, the search results 108 may be transmitted as a search results web page to be displayed via the browser 107 executing on the client device 106 and/or as one or more search results conveyed to a user via audio.

In some implementations, the search system 102 provides the ordered collection of information more prominently in the search results 108 and/or otherwise distinguished from other of the search results 108. For example, when the search results 108 are presented as a search results webpage, the ordered collection of information may be displayed more prominently and/or may be positonally offset from other of the search results 108 as illustrated in FIGS. 7A and 7B.

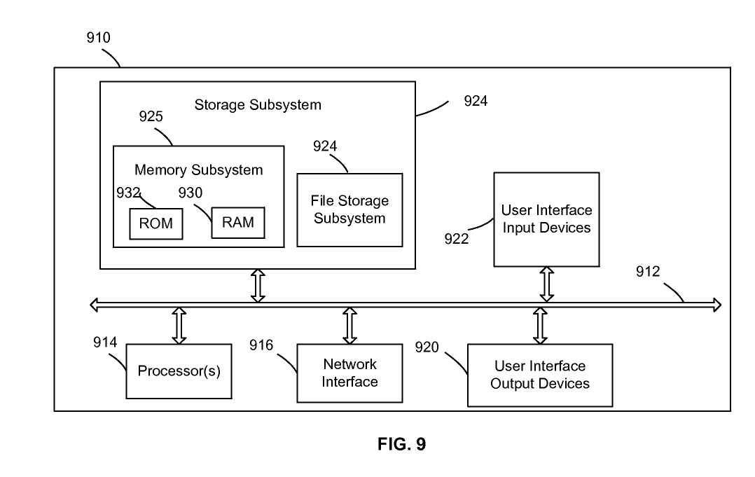

The search system 102, the processing system 120, the client device 106, and/or one or more additional components of the example environment of FIG. 1 may each include memory for storage of data and software applications, a processor for accessing data and executing applications, and components that facilitate communication over a network. In some implementations, such components may include hardware that shares one or more characteristics with the example computer system that is illustrated in FIG. 9. The operations performed by one or more components of the example environment may optionally be distributed across multiple computer systems. For example, the steps performed by the search system 102 may be performed via one or more computer programs running on one or more servers in one or more locations that are coupled to each other through a network.

Many other configurations are possible having more or fewer components than the environment shown in FIG. 1. For example, in some environments one or more aspects described herein with respect to the document ranking engine 110, the table ranking engine 112, and/or the table information engine 135 may be may be implemented in other of the engines 110, 112, and/or 135, or combined in a single engine. Also, for example, in some implementations the table information database 156 may be included in the document index 154. Also, for example, in some implementations one or more of the components 112, 135, and 156 may be separate from the search system 102. Also, for example, in some implementations the table information database 156 may be omitted and the table information engine 135 may provide information to the table ranking engine 112 directly.

With reference to FIGS. 2-5, additional description is provided of the table information engine 135 and the table information database 156. FIG. 2 illustrates a table engine 137 and an additional information engine 139 of the table information engine 135. Generally, the table engine 137 identifies a table in a document and determines information about the table based on content of the table in the document. Generally, the additional information engine 139 identifies additional content external to the content of the table itself, and determines information about the table based on the additional content and optionally based on the information identified by the table engine 137. In some implementations, one or more aspects of the table engine 137 and additional information engine 139 may be combined.

The table engine 137 and/or the additional information engine 139 may, for a given table: determine whether the table includes an ordered collection; determine one or more features of the table such as one or more subjects, attributes, modifiers, and/or superlatives of the table and/or indications of which columns of the table are sorted measure, rank, category, and/or subject columns; determine from which columns content should be extracted and stored separately from the document (e.g., in table information database 156) for future utilization in an ordered collection of information provided in response to a search query; and/or determine from which columns content should be extracted in the future for utilization in an ordered collection of information provided in response to a search query. In some implementations, the table information engine 135 may store determined features and/or content of a table in table information database 156 based on information determined by the table engine 137 and/or additional information engine 139.

The table engine 137 may identify a table in a document based on one or more techniques. For example, the table engine 137 may utilize a rules-based approach to identify tables based on one or more tags related to a table in metadata of the document. For example, for an HTML document, the table engine 137 may identify a table based on the presence of one or more tags such as “<table>”, “<tr>”, “<td>”, “<div>”, and/or “<th>” in the metadata of the document. Additional and/or alternative techniques to identify a table in a document may be utilized. For example, other rules-based techniques and/or machine-learning techniques may be utilized. Also, for example, visual style(s) of a document may be utilized to identify a table in the document.

The table engine 137 may further identify information about the table based on content of the table. In some implementations, the table engine 137 may identify sorted measure columns in the table that include measures that have been sorted. For example, the “Elevation” column of table 161B of FIG. 4 is a sorted measure column as it is sorted in descending order based on elevation in feet. As one example, the table engine 137 may identify a sorted measure column based on calculating a difference between the measures of adjacent cells of the column and determining that each cell in the column decreases (or increases) relative to the previous cell. As another example, the table engine 137 may additionally and/or alternatively identify a sorted measure column based on: masking numerical measures of cells of the column and determining an average edit distance of all non-numerical content for all pairs of cells is less than a threshold; and determining the length of the longest increasing subsequence of the numerical measures is no less than a threshold number and/or percentage of the total number of cells in the column. As yet another example, the table engine 137 may additionally and/or alternatively identify a sorted measure column based on identifying text indicative of measurement units in one or more cells in the column (e.g., “feet”, “ft.”, “mm”).

In some implementations, the table engine 137 may identify an attribute of the table based on the header of an identified sorted measure column (e.g., a header in the same table or a header that immediately precedes but is technically separate from the table) and/or based on other cells in the column. The attribute of the table indicates a measure by which the table is ranked. For example, the table of FIG. 4 is ranked based on the attribute of “Elevation”. In some implementations, one or more terms of the header may be utilized as the identified attribute. In some implementations, one or more other indications determined based on the terms of the header and/or the terms of other cells of the sorted measure column may additionally and/or alternatively be utilized as an identified attribute. For example, synonyms or other terms related to the one or more terms of the header may be utilized as an identified attribute. Also, for example, an entity identifier associated with the one or more terms of the header and/or associated with terms of other cells of the sorted measure column may be utilized. For example, an entity identifier associated with one or more of the terms of other cells of the sorted measure column may be utilized.

In some implementations, the table engine 137 may identify a rank column in the table that includes a numerical or other indication (e.g., A, B, C) of rank. For example, the “Rank” column of table 161B of FIG. 4 is a rank column as it includes a numerical indication of rank. As one example, the table engine 137 may identify a rank column based on determining presence of a rank term in the header of the column such as “rank”, “ranking”, “position”, etc. As another example, the table engine 137 may additionally and/or alternatively identify a rank column based on calculating a difference between the measures of adjacent cells of the column and determining that the difference of each cell in the column relative to the previous cell satisfies one or more measures, such as “0”, “1”, and/or a calculated measure.

In some implementations, the table engine 137 may identify a category column in the table that includes indications of categories of the subject of the table. As described herein, the subject of the table identifies a type of the entities that are ranked in the table. For example, the subject of the table 161B of FIG. 4 may be “Mountain” and/or an entity associated with “Mountain” as each of the listed entities (“Mount Whitney”, “Mount Williamson”, etc.) is a mountain. The “Range” column of table 161B is a category column as it provides an indication of divisions of the entities of the subject of the table based on the mountain range of the entities. As one example, the table engine 137 may identify a category column based on determining the number of unique values of cells of the column (optionally excluding the header) satisfies some measure. For example, the table engine 137 may identify a column as a category column based on determining the number of unique values is less than or equal to 50% of the total number of cells in the column (optionally excluding the header). For instance, the “Range” column of FIG. 4 contains only 3 unique values (“Sierra Nevada”, “White Mountains”, “Cascades”) in the 6 cells of the column (excluding the header).

In some implementations, the table engine 137 may identify a category of the category column based on the header of an identified category column. In some implementations, one or more terms of the header may be utilized as an identified category. In some implementations, one or more other indications determined based on the one or more terms of the header may additionally and/or alternatively be utilized as the identified category such as synonyms of the terms and/or an entity identifier associated with the terms.

In some implementations, the table engine 137 may identify the unique values in the cells of the category column and identify the unique values as modifiers of the table and/or as category members of the category. For example, the table engine 137 may extract the unique cells of the category column, identify each unique cell as a modifier of the table and as a category member of the category, and/or associate the unique cells with the row(s) in which the category member occurs. For example, for the “Range” column of the table 161B of FIG. 4, “Sierra Nevada”, “White Mountains”, and “Cascades” may each be identified as a modifier of the table, associated with the category “Range”, and associated with the row(s) in which they occur. In some implementations a unique value may be utilized as an identified category member. In some implementations, one or more other indications determined based on the unique value may additionally and/or alternatively be utilized such as synonyms of the unique value and/or an entity identifier associated with the unique value.

In some implementations, the table engine 137 may identify a subject column and identify a subject of the table based on the header of the subject column. For example, the table engine 137 may identify the column that is immediately to the right of a determined “rank” column as the subject column and identify a subject of the table based on the header of that column. In some implementations, the text of the header may be utilized as the identified subject. In some implementations, one or more other indications determined based on the text of the header may additionally and/or alternatively be utilized as the identified subject such as synonyms of the text and/or an entity identifier associated with the text.

The additional information engine 139 identifies additional content external to the content of the table itself and determines information about the table based on the additional content and/or the information identified by the table engine 137. In some implementations, the additional information engine 139 identifies additional content that is content of the document, but external from the table of the document. For example, the additional information engine 139 may identify additional content from the title of the document and/or from text in the body of the document. Text in the body of the document from which additional content may be identified includes, for example, text within a threshold distance of the table, text from a caption of the table, and/or text from one or more headings of the document.

In some implementations, the additional information engine 139 may determine one or more features of the table based on the additional content of the document. For example, the additional information engine 139 may provide the title of the document to another component (e.g., processing system 120) and receive annotations of one or more types of grammatical information for terms of the title of the document. In some other implementations, the additional information engine 139 may itself annotate the one or more types of grammatical information. The additional information engine 139 may determine one or more features of the table based on the annotations of the title such as a subject, attribute, modifier, and/or superlative of the table.

The features determined by the additional information engine 139 may be in addition to any determinations of features by the table engine 137 and/or may verify accuracy of determinations made by the table engine 137. For example, the table engine 137 may not have determined a subject and a subject determined by the additional information engine 139 may be in addition to the determinations of the table engine 137. Also, for example, the table engine 137 may have determined a subject and a subject determined by the additional information engine 139 may be utilized as an additional subject (e.g., engine 137 determined “Elevation” and engine 139 may determine “Height” as an additional subject). Also, for example, the table engine 137 may have determined two potential subjects and a subject determined by the additional information engine 139 may be utilized to determine one of the two is more likely the correct subject.

As one example, the additional information engine 139 may provide the title of the document to the processing system 120, such as the title 162B of document 160B of FIG. 4. The processing system 120 may annotate the syntactic relationship between the terms of the title and annotate the terms with respective parts of speech such as subject, modifier, superlative, number, and/or stopword. The processing system 120 may optionally rewrite the title based on one or more rewriting rules to improve annotations for table features determination. The additional information engine 139 may determine one or more of the terms correspond to a feature of the table based on the syntactic and/or parts of speech annotations. For example, the additional information engine 139 may determine a subject of the table based on the term annotated as a subject that is closest to the root (as indicated by the annotated syntactic relationship). Also, for example, the additional information engine 139 may determine a superlative of the table based on the term annotated as a superlative that is closest to the root. Also, for example, the additional information engine 139 may determine an attribute of the table based on the term annotated as a modifier that is closest to the root and/or closest to a term labeled as a superlative. Also, for example, the additional information engine 139 may determine one or more modifiers of the table based on the terms annotated as a modifier that are not closest to the root and/or closest to a term labeled as a superlative.

In some implementations, the term of the title that corresponds to a feature of the table may be utilized as the identified feature. In some implementations, one or more other indications determined based on the term of the title may additionally and/or alternatively be utilized as the identified feature such as synonyms of the term and/or an entity identifier associated with the term.

In some implementations, the processing system 120, the additional information engine 139, and/or other component may optionally annotate other types of information for terms of the title. The additional information engine 139 may determine one or more of the terms correspond to a feature of the table based on one or more of such additional annotations. For example, the processing system 120 may annotate a likelihood that a subject is a table subject and/or a likelihood that a modifier is a table attribute. In some implementations, the likelihood a subject is a table subject may be based on a quantity of occurrences of the subject as a table subject in a corpus of tables with annotated subject information. The annotated subject information may be annotated by human reviewers and/or annotated based on determinations of table engine 137 and/or additional information engine 139. Likewise, in some implementations the likelihood a modifier is a table attribute may be based on a quantity of occurrences of the modifier as a table attribute in a corpus of tables with annotated attribute information.

Examples of determining one or more features of a table of a document based on the additional content of the document have been described utilizing a title of the document. In some implementations, the additional information engine 139 may determine one or more features additionally and/or alternatively based on other segments of the document, such as a textual segment that precedes or follows the table. For example, the textual segment 163B that precedes the table 161B in FIG. 4 may be utilized. Also, for example, one or more of the headings that are nearest to the table, one or more headings that have the greatest degree of similarity to the table (e.g., similarity between terms of the heading(s) and terms of the table), texts that immediately precedes or follows a reference to the table, and/or a caption of the table may be utilized.

In some implementations, the additional information engine 139 identifies additional content that is external to the content of the document itself and determines one or more features of a table of a document based on such additional content. For example, the additional information engine 139 may identify additional content from one or more other documents that are responsive to the same queries to which the document that contains the table is responsive. For instance, content may be identified one or more other documents that are “highly ranked” for one or more of the same queries to which the document that contains the table is responsive (e.g., the ranking of other documents may be based on selection rates of the other documents for the query, similarity of the other documents to the query, and/or other raking factors). As another example, the additional information engine 139 may identify information related to one or more queries to which the electronic document is responsive from query information for documents database 165. Query information for documents database 165 includes identifiers of documents and, for each identifier, a mapping to information related to one or more queries to which the document identified by the identifier is responsive. For example, an identifier of a document may be mapped in the database 165 to the entirety of a query, key terms from a query, one or more entities referenced by a query, a measure indicative of a number of submissions of a query, and/or other information related to a query.

In some implementations, the query information included in the database 165 may be restricted based on one or more criteria and/or the query information identified by the additional information engine 139 may be identified based on one or more criteria. For example, in some implementations the additional information engine 139 may only identify those queries for a given document in which the given document is selected at least a threshold number of times and/or with at least a threshold frequency responsive to the queries. Also, for example, in some implementations the additional information engine 139 may only identify those queries for a given document that are superlative queries. In some implementations, a superlative query is a query that contains a superlative term (e.g., most, highest, richest, tallest). In some implementations, the processing system 120 and/or other component may identify a query as a superlative query based on part of speech tagging of the query, other annotations of the query, and/or matching one or more terms of the query to a list of superlative terms.

As one example, the additional information engine 139 may, for a table of a document, identify one or more queries to which the document is responsive from the queries for documents database 165. For example, the additional information engine 139 may identify only queries that are superlative. Also, for example, the additional information engine 139 may additionally and/or alternatively identify only queries that that contain one or more terms in the headers of the table (e.g., as identified by table engine 137) such as one or more terms in any header or one or more terms in the header of the sorted measure column, attribute column, and/or subject column. Also, for example, the additional information engine 139 may additionally and/or alternatively identify only queries that are associated with at least a threshold level of selection of the document in response to the query.

The additional information engine 139 may provide the identified queries to the processing system 120 and the processing system 120 may, for each of the queries, annotate the syntactic relationship between the terms of the query and/or annotate the terms with respective parts of speech such as subject, modifier, superlative, number, and/or stopword. The processing system 120 may optionally rewrite each of the queries based on one or more rewriting rules to improve annotations for table features determination.

The additional information engine 139 may determine one or more of the terms of the queries correspond to a feature of the table based on the syntactic annotations of the terms, parts of speech annotations of the terms, and/or based on a quantity of occurrences of the terms in the identified queries. For example, the additional information engine 139 may determine the subject of the table based on a term of the identified queries—based on the quantity of occurrences of the term being annotated as a subject in the identified queries, based on quantity of occurrences of the term in the identified queries, and/or based on the closeness of the term to the root in the identified queries. Also, for example, the additional information engine 139 may determine a superlative of the table based on a term of the identified queries—based on the quantity of occurrences of the term being annotated as a superlative in the identified queries, based on quantity of occurrences of the term in the identified queries, and/or based on the closeness of the term to the root in the identified queries. Also, for example, the additional information engine 139 may determine the attribute of the table based on a term of the identified queries—based on the quantity of occurrences of the term being annotated as a modifier in the identified queries, based on quantity of occurrences of the term in the identified queries, and/or based on the closeness of the term to the root and/or a superlative in the identified queries. Also, for example, the additional information engine 139 may determine one or more modifiers of the table based on a term of the identified queries—based on the quantity of occurrences of the term being annotated as a modifier in the identified queries, based on quantity of occurrences of the term in the identified queries, and/or based on the closeness of the term to the root and/or a superlative relative to other modifiers in the identified queries.

In some implementations, the term(s) of the queries that correspond to a feature of the table may be utilized as the identified feature. In some implementations, one or more other indications determined based on the term(s) of the queries may additionally and/or alternatively be utilized as the identified feature such as synonyms of the term(s) and/or an entity identifier associated with the term(s).

In some implementations, the processing system 120, the additional information engine 139, and/or other component may optionally annotate other types of information for terms of the query. The additional information engine 139 may determine one or more of the terms correspond to a feature of the table based on one or more of such additional annotations. For example, the processing system 120 may annotate a likelihood that a subject is a table subject and/or a likelihood that a modifier is a table attribute. The additional information engine 139 may determine one or more of the terms correspond to a feature of the table based at least in part on such annotated likelihoods. Also, for example, an entity and/or entity class/type associated may be annotated for the query and the processing system 120 may compare such information to one or more entities and/or entity types present in cells of a table. The processing system 120 may annotate a degree of matching between the query entities and/or entity types and the table entities and/or entity types and the additional information engine 139 may determine how closely the query and the table match based on one or more of such annotations of the table.

Information determined for a table of a document by the table engine 137 and/or additional information engine 139 may be utilized for one or more purposes. For example, the table information engine 135 may store determined features such as subject, attribute, determined types of columns (sorted measure, rank, etc.), and/or content of a table in table information database 156 for utilization by the table ranking engine 112.

FIG. 3 illustrates example entries 156A-C of the table information database 156. Each of the entries 156A-C reflects information about a table of a document. Each of the entries 156A-C includes an identifier that identifies the document in which the table is provided (D1, D2, D3) and also identifies the table within the document (T1). The identifier of the table within the document may be utilized to disambiguate between multiple tables of a document and/or to assist in identifying the table within the document. In some implementations the identifier of the table within the document may be omitted. Each of the entries 156A-C also includes identifiers of the subjects, attributes, modifiers, and superlatives of the table.

For example, entry 1566 may be based on table 1616 of FIG. 4. The entry 1566 includes an identifier of the subject of “Mountain”, an identifier of the attribute of “Elevation”, and an identifier of the superlative of “Highest.” Although only one identifier is included for each of the preceding features, in some implementations multiple identifiers may be provided and/or indicated. For example, in some implementations “highest” and “tallest” may both be included as superlatives for entry 1566 and/or an identifier that encompasses both highest and tallest may be included. For instance, as described above, the additional information engine 139 may identify superlatives of “highest” and “tallest” based on frequency of occurrence of both of those terms in queries to which document 1606 is responsive.

The entry 1566 also includes a modifier of “California” that may be identified as a modifier of the table. As described above, the additional information engine 139 may identify the modifier “California” based on title 1626 and/or segment 1636 of document 1606 and/or based on frequency of occurrence of “California” in queries to which document 1606 is responsive. The entry 1566 also includes modifiers of “Sierra Nevada”, “Cascades”, and “White Mountains” that are members of the category of “Range” and indicated as members of the category of “Range” in the entry 1566. As described above, the table engine 137 may identify the category and/or the members of the category based on analysis of the content of the table 1616.

In some implementations, one or more of the entries 156A-C may include other information in addition to, or as an alternative to, the information provided in FIG. 3. For example, information may additionally and/or alternatively be provided to identify which columns of a table are sorted measure, rank, category, and/or subject columns. For instance, the subject of each entry may be associated with a column identifier identifying which column of the table is the subject column. Also, for example, information may additionally and/or alternatively be provided to determine from which columns content should be extracted in the future for utilization in an ordered collection of information provided in response to a search query. For instance, the “Sierra Nevada” identifier of entry 156B may be provided with an indication of the rows of the table that include “Sierra Nevada” Also, for example, the category class of “Range” may be associated with a popularity measure determined by additional information engine 139 that indicates popularity of the term in queries to which the document 160B is responsive. Such a popularity measure may be used, for example, by the table ranking engine 112 to determine whether information from the “Range” column should be provided in an ordered collection of information. Also, for example, in some implementations all or portions of the content of a table may be included in an entry of the table to enable determination of an ordered collection of information based on the entry without accessing the document 160B. For instance, the entry 156B may include the entire contents of the table 161B.

FIG. 5 is a flow chart illustrating an example method of determining a table of a document includes an ordered collection of information and determining one or more table features of the table. Other implementations may perform the steps in a different order, omit certain steps, and/or perform different and/or additional steps than those illustrated in FIG. 5. For convenience, aspects of FIG. 5 will be described with reference to a system of one or more computers that perform the process. The system may include, for example, the table information engine 135 of FIGS. 1 and 2.

At step 500, content of a table of a document is identified. For example, the table engine 137 may identify a table in a webpage based on one or more techniques and identify content from the table. For example, the table engine 137 may utilize a rules-based approach to identify one or more tags related to a table in metadata of the webpage and identify content related to the one or more tags.

At step 505, it is determined that the table includes an ordered collection. In some implementations, a table may be determined to include an ordered collection based on determining one or more features of the table that are indicative of an ordered collection. For example, in some implementations, a table may be determined to include an ordered collection based on identifying a sorted measure column in the table that includes measures that have been sorted. For example, the “Elevation” column of table 161B of FIG. 4 is a sorted measure column as it is sorted in descending order based on elevation in feet. As one example, the table engine 137 may identify a sorted measure column based on calculating a difference between the measures of adjacent cells of the column and determining that each cell in the column decreases (or increases) relative to the previous cell.

Also, for example, in some implementations, a table may be determined to include an ordered collection based on identifying the table includes a rank column. For example, the table engine 137 may identify a rank column in the table that includes a numerical or other indication of rank. Also, for example, in some implementations, a table may be determined to include an ordered collection based on content external to the table, such as other content of the document in which the table is provided and/or queries to which the document is responsive. For example, a table may be determined to include an ordered collection based on identifying a superlative of the table based on the title of the document in which the table is provided and/or based on queries to which the document is responsive. Additional and/or alternative determined features of the table may be utilized to determine the table includes an ordered collection such as features described above with respect to engine 137 and/or engine 139.

At step 510, one or more of a subject, an attribute, a superlative, and a modifier of the table are determined. In some implementations, one or more of the subject, attribute, superlative, and modifier may be determined based at least in part on content of the table itself. In some implementations, one or more of the subject, attribute, superlative, and modifier may additionally and/or alternatively be determined based at least in part on content external to the content of the table. In some implementations, the table engine 137 and/or the additional information engine 139 may determine one or more of the subject, attribute, superlative, and modifier based on one or more techniques such as those described above.

At step 515, the one or more of the subject, the attribute, the superlative, and the modifier are associated with an identifier of the document. For example, the table information engine 135 may store the one or more of the subject, the attribute, the superlative, and the modifier in table information database 156 for utilization by the table ranking engine 112. In some implementations, the table information database 156 is an index including a plurality of entries, with each of the entries including one or more features of a table (e.g., features related to a subject, attribute, modifier, and/or superlative of the table as described herein) and an identifier of a document in which the table is provided. In some implementations other determined features for the table such as determined types of columns (sorted measure, rank, etc.) and/or content of a table may also be associated with an identifier of the document in table information database 156.

The steps of FIG. 5 may be repeated for each of a plurality of tables and/or documents to determine features of tables that include an ordered collection. In some implementations, the steps of FIG. 5 and/or other steps may be performed on a periodic or other basis to update existing feature of tables and/or discover features of new tables.

With reference to FIGS. 6-8, additional description is provided of the table ranking engine 112. Generally, the table ranking engine 112 determines one or more tables that are responsive to a search query and determines an ordered collection of information based on content of the selected one or more tables. FIG. 2 illustrates a table selector 114, a selected table column/row selector 116, and a table presentation engine 118 of the table ranking engine 112. Generally, the table selector 114 determines one or more tables that are responsive to a search query 104 based on information related to the search query 104 and based on information from table information database 156. For example, the table selector 114 may identify one or more search query terms based on query 104 and determine a plurality of candidate tables from database 156 that are associated with one or more features that match the identified search query terms. The table selector 114 may select one or more tables from the candidate tables based on one or more criteria.

Generally, the table column/row selector 116 may select content associated with all, or a subset of, a selected table for inclusion in an ordered collection of information. The table column/row selector may optionally utilize, for example, one or more rules and/or information identified from the table information database 156, one or more other documents that are responsive to the same queries to which the document that contains the table is responsive, the processed query 104a, and/or the client device 106 in determining content to select. Generally, the table presentation engine 118 prepares the ordered collection for providing with the search results 108. For example, the table presentation engine 118 may prepare the ordered collection for display as a table, for display as a non-table collection, and/or may prepare one or more explanations, links, and/or other features for inclusion with the ordered collection.

As described herein, the document ranking engine 110 identifies documents that are responsive to a search query 104 and ranks the responsive documents based on one or more signals. In some implementations, the document ranking engine 110 provides the table ranking engine 112 with an indication of one or more of the responsive documents and/or an indication of the ranking of one or more of the documents. For example, in some implementations the document ranking engine 110 provides the table ranking engine 112 with identifiers of the 10, 20, 30, or 40 highest ranked documents and optionally an indication of the ranking of those documents (e.g., a numerical ranking and/or the calculated relevance scores for the documents). The ranking engine 112 may identify one or more entries in the table information database based on the provided identifiers of the documents. For example, 20 identifiers may be provided and the ranking engine 112 may identify 3 of those identifiers match entries in the database. For instance, the identifiers provided by document ranking engine 110 may include identifier D2 of a document and the ranking engine may identify entry 156B of FIG. 3 is associated with the identifier D2.

For each of the identified entries, the table ranking engine 112 may compare one or more features of the entry to one or more terms of the search query 104 and determine matches between the terms of the search query 104 and the features of the entry. In some implementations, the one or more features of the entry to which the terms of the search query 104 are compared may include, or be restricted to, one or more subjects, attributes, modifiers, and/or superlatives of the entry. For example, assume the search query 104 is “highest mountains in CA” and the identified entry is entry 156B of FIG. 3. The table ranking engine 112 may determine that “highest” matches the superlative of entry 156B, “mountains” matches the subject of entry 156B, and “CA” matches a modifier (“California”) of entry 156B. Exact matching and/or soft matching may be utilized. For example, “CA” may be determined to match “California” based on a mapping between the two terms in an entity database and/or other database. Also, for example, “tallest” may be determined to match “highest” based on a mapping between those terms in a synonyms database and/or other database. In some implementations where soft matching is utilized a degree of matching may also be determined.

In some implementations, a given term of a search query may be compared to multiple features in an entry to determine if the given term matches with any of the features. In some other implementations, the processing system 120 may annotate one or more terms of a search query in a similar manner as described with respect to annotating a title of a document. The table ranking engine 112 may utilize such annotations to determine if a term of a search query should be matched to, for example, a subject, an attribute, a modifier, or other attribute of the entry. For example, for a term annotated as a superlative, the table ranking engine 112 may compare that term only to a superlative feature of the entry.

In some implementations, the table selector 114 may utilize a measure associated with the matches between the terms of the search query 104 and the features of an entry to determine if the entry is responsive to the query and/or to determine a relevance score for the entry. For example, the table selector 114 may compare the measure to a threshold and determine the entry is responsive to the search query 104 if the threshold is satisfied. For instance, the measure may be the quantity of matches and the threshold may be two. Also, for example, the table selector 114 may utilize the measure in determining a relevance score. The measure may be based on one or more of: the quantity of matches between the terms of the search query 104 and the features of the entry (e.g., more matches may be more indicative of the table being responsive to the search query and/or more indicative of relevance); the types of the features of the entry for which there is a match (e.g., matches related to a subject of the table and/or an attribute of the table may be weighted more heavily than matches to other features); the quantity of matches between the terms of the search query 104 and the features of the entry compared to some other quantity such as a fixed value, a number of columns of the table associated with the entry, etc.

In some implementations, the table selector 114 may determine only a single entry that is responsive to the search query 104. For example, assume the document ranking engine 110 provides the table ranking engine 112 with identifiers of 20 responsive documents for the search query 104 and an indication of the ranking of the documents. In some implementations, the ranking engine 112 may identify 3 of those identifiers match entries in the database and determine that, of those entries, only a single entry has a measure associated with matches between the terms of the search query 104 and the features of the entry that indicates the entry is responsive to the search query 104. The ranking engine 112 may determine only that single entry is responsive to the search query 104. In some implementations, the ranking engine 112 may select only the entry associated with the highest ranked document (as indicated by document ranking engine 110) that includes a measure associated with matches that indicates the entry is responsive to the query 104—without reference to any other entries.

In some implementations, the table selector 114 may determine multiple candidate entries that are responsive to the search query 104. For example, assume the document ranking engine 110 provides the table ranking engine 112 with identifiers of 20 responsive documents for the search query 104 and an indication of the ranking of the documents. The ranking engine 112 may identify 5 of those identifiers match entries in the database and determine that all 5 have a measure associated with matches between the terms of the search query 104 and the features of the entry that indicates the entry is responsive to the search query 104.

In implementations where the table selector 114 determines multiple candidate entries, the table selector 114 may utilize one or more techniques to select a subset of those entries. For example, the table selector 114 may select the entry that is associated with a document having the highest ranking as indicated by document ranking engine 110. Also, for example, the table selector 114 may determine relevance scores for the entries and select one or more of the entries based on the relevance scores.

In some implementations the relevance score for an entry may be based on the measure associated with the matches between the terms of the search query 104 and the features of an entry, as described above. In some implementations, the relevance score for an entry may additionally and/or alternatively be based on the ranking and/or relevance score of the document associated with the document identifier of the entry as provided by the document ranking engine 110. For example, a top ranking of a document may more positively influence the relevance score than a lesser ranking.

In some implementations, the relevance score for an entry may additionally and/or alternatively be based on signals related to one or more other queries from query information for documents database 165 that are responsive to a document associated with the entry. For example, for a given entry the table selector 114 may identify one or more queries: for which a document identified by the entry is responsive, and that contain one or more terms of the query 104 that match a feature of the entry. One or more additional criteria may be utilized in identifying the queries such as a number and/or frequency of selections of the document in response to the queries, only identifying superlative queries, etc. The table selector 114 may determine the relevance score based on one or more signals associated with such identified queries. For example, the signals may include one or more selection rates for the document for the queries, one or more scores for the document for the queries, an overall popularity measure of the queries, etc.

As one example, the query 104 may be “best football club in europe” and a given entry may include features that match “football” and “europe” and may be associated with an identifier of document A. The table selector 114 may identify all queries from database 165 that are superlative and that include the term “football” or the term “europe”. The table selector 114 may further determine an average selection rate of document A for all such identified queries and determine the relevance score based at least in part on the selection rate. For example, a relatively high selection rate may be more indicative of relevance than a relatively low selection rate.

The table column/row selector 116 may select content associated with all, or a subset of, one or more tables associated with the one or more entries selected by the table selector 114. The content selected by the table column/row selector 116 may be included in an ordered collection of information provided with the search results.

In some implementations, the table column/row selector 116 may optionally utilize, for example, one or more rules and/or information identified from the table information database 156, the query 104, and/or the client device 106 in determining content to select. For example, one or more rules may indicate that the selector 116 should always select content from the subject column and the attribute column. Also, for example, one or more rules may indicate that when selecting among a plurality of columns that include modifiers, the leftmost columns should be favored absent any other considerations. Also, for example, one or more rules may indicate that no more than 5 rows should be selected. Also, for example, the table information database 156 may already include an indication of appropriate columns and/or rows for inclusion in an ordered collection and/or may already include content from such appropriate columns and/or rows. Also, for example, the selector 116 may receive one or more signals from the client device 106 that are indicative of a size of a display of the client device 106 and determine a number of columns and/or rows to display based on those signals. For example, more columns and/or rows may be selected if the signals indicate a desktop computer than would be selected if the signals indicated a mobile phone.

Also, for example, the selector 116 may select one or more columns and/or rows based on one or more terms of the search query 104. For example, the selector 116 may select a column that includes a modifier as a heading based on the modifier matching a term in the search query 104. Also, for example, the selector 116 may select only rows that include a modifier that is a member of a category based on the modifier matching a term in the search query 104. For example, for a search query of “highest california mountains in the sierra nevada” for which entry 156B is selected, only those rows that include “Sierra Nevada” for the category “Range” may be selected. Also, for example, the selector 116 may order rows that include a modifier that is a member of a category higher in an ordered collection of information based on the modifier matching a term in the search query 104. For example, for a search query of “highest california mountains in the sierra nevada” for which entry 156B is selected, those rows that include “Sierra Nevada” for the category “Range” may be ordered above other rows that do not include “Sierra Nevada”. Also, for example, the selector 116 may select one or more columns based on headers of those columns matching terms in one or more other search queries for which the document in which the table is provided is responsive. For example, queries to which the document is responsive may be identified from query information for documents database 165 and frequent terms from those queries that match a header of a column may be identified. Based on the matching, the selector 116 may determine the column should be selected. Also, for example, the selector 116 may determine which columns of a table should be selected based on a general popularity of the columns (e.g., a popularity not related to a specific query or document)

As described herein, in some implementations the selected content may be included in the table information database 156 and the selector 116 may retrieve the content from the database 156. In some implementations, the selector 116 may extract the content from the document in which the table is provided.

The table presentation engine 118 prepares the ordered collection for providing with the search results 108. For example, when the search results are provided as information to be displayed, the table presentation engine 118 may prepare the ordered collection for display as a table, such as table 780A illustrated in FIG. 7A. In some implementations, the table presentation engine 118 may utilize one or more properties of the table of the document in preparing the ordered collection for display as a table. For example, one or more aspects of the formatting of the table in the document may be utilized such as utilization of one or more of the same headers as those present in the document, utilization of the same borders and/or color(s) as those present in the document, etc. Also, for example, the table presentation engine 118 may prepare the ordered collection for display as a non-table collection such as non-table collection 780B illustrated in FIG. 7B.

In some implementations, the table presentation engine 118 may also prepare one or more explanations, links, and/or other features for inclusion with the ordered collection. For example, the table presentation engine 118 may indicate a document on which the ordered collection of information is based as indicated in the explanation (“Based on exampleurl.com”) above the tables 780A and 780B in FIGS. 7A and 7B. Also, for example, the table presentation engine 118 may indicate the information reflected by the ordered collection of information as indicated in the explanation (“the highest mountains in California include”) above the tables 780A and 780B in FIGS. 7A and 7B. The table presentation engine 118 may determine the indication of the information reflected based on one or more sources such as the search query and/or the table features. Also, for example, the table presentation engine 118 may determine one or more links for including with the ordered collection of information. For example, the table presentation engine 118 may include a link to exampleurl.com as indicated by the underlining in the explanation (“exampleurl.com”) above the tables 780A and 780B in FIGS. 7A and 7B. Also, for example, the table presentation engine 118 may include embedded instructions to display more of the ordered collection when only a portion of available content is initially displayed in the ordered collection. For example, selection of “Click to see more” below the tables 780A and 780B in FIGS. 7A and 7B may cause the client device 106 to execute instructions and display additional rows of the ordered collection (e.g., the additional rows of table 161B in FIG. 4).

In some implementations, the table presentation engine 118 prepares the ordered collection for providing in audio and/or other form. The search results 108 are transmitted to the client device 106 in a form that may be presented to the user. For example, the search results 108 may be transmitted by the search system 102 as a search results web page to be displayed via the browser 107 executing on the client device 106 and/or as one or more search results conveyed to a user via audio.

Examples of determining an ordered collection of information have been described in response to a search query 104 received from a client device 106. In some implementations, the table ranking engine 112 may determine an ordered collection of information for a previously submitted query and store the determined ordered collection of information for providing in response to a future query that matches (soft or exact) the previously submitted query. For example, the table ranking engine 112 may determine ordered collections of information for a set of queries such as all previously submitted superlative queries, automatically generated superlative queries, and/or the most popular previously submitted superlative queries. Also, examples of determining an ordered collection of information have been described based on accessing certain information related to tables from table information database 156 that has been previously stored based on analysis performed by table information engine 135. In some implementations, the table information engine 135 may determine information related to one or more tables (e.g., features) and provide such information to table ranking engine 112 without first storing such information in table information database 156.

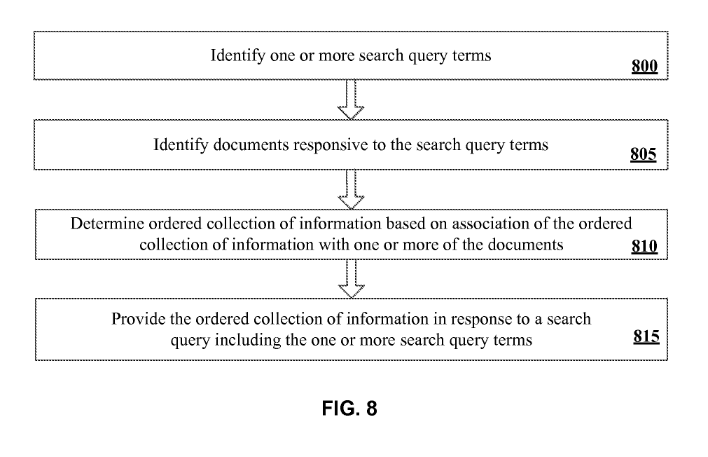

FIG. 8 is a flow chart illustrating an example method of determining an ordered collection of information that is responsive to search query terms, wherein the ordered collection of information is based at least in part on content of a table of a document that is responsive to the search query terms. Other implementations may perform the steps in a different order, omit certain steps, and/or perform different and/or additional steps than those illustrated in FIG. 8. For convenience, aspects of FIG. 8 will be described with reference to a system of one or more computers that perform the process. The system may include, for example, the table ranking engine 112 of FIGS. 1 and 6 and/or the document ranking engine 110 of FIG. 1.

At step 800, one or more search query terms are identified. For example, in some implementations the table ranking engine 112 may identify one or more terms of a search query 104 submitted by client device 106. Also, for example, in some implementations the table ranking engine 112 may identify one or more terms of a previously submitted search query.

At step 805, documents responsive to the search query terms are identified. For example, in some implementations the document ranking engine 110 may use the index 154 to identify documents responsive to the search query terms.

At step 810, an ordered collection of information is determined based on association of the collection with one or more of the documents. For example, the document ranking engine 110 may provide the table ranking engine 112 with an indication of one or more of the responsive documents and/or an indication of the ranking of one or more of the documents. The ranking engine 112 may identify one or more entries in the table information database 156 based on the provided identifiers of the documents and determine an ordered collection of information based on content of one or more tables associated with one or more of the entries.

For example, in some implementations the document ranking engine 110 provides the table ranking engine 112 with identifiers of the 20 highest ranked documents and the ranking engine 112 may identify 3 of those identifiers match entries in the table information database 156. In some implementations, the table ranking engine may select one or more of those identified entries and utilize content associated with the table associated with the selected entries to determine the ordered collection of information.

In some implementations, the table ranking engine 112 may utilize information from the table information database 156 to select one or more tables from those entries that are associated with the responsive documents. For example, the table ranking engine 112 may select one or more of the tables based on matching of the search query 104 to one or more features of the tables in database 156 and/or based on other techniques. The table ranking engine 112 may optionally calculate relevance scores for the tables, for example, using one or more ranking signals such as those described herein. The table ranking engine 112 may use the scores, for example, to select one or more tables from a larger group of candidate tables.

The table ranking engine 112 determines an ordered collection of information based on content of the selected one or more tables. For example, the table ranking engine 112 may extract content of a table from the document in which the table is provided and utilize the content to determine the ordered collection of information. For instance, content from one or more rows and/or columns of the table may be utilized as the ordered collection of information. Also, for example, the table information database 156 may include information related to previously extracted content of a table and the table ranking engine 112 may utilize such information to determine the ordered collection of information.

At step 815, the ordered collection is provided in response to a search query including the one or more terms. For example, the table presentation engine 118 may prepare the ordered collection for providing with the search results. For example, when the search results are provided as information to be displayed, the table presentation engine 118 may prepare the ordered collection for display as a table and/or for display as a non-table collection. In some implementations, the table presentation engine 118 may also prepare one or more explanations, links, and/or other features for inclusion with the ordered collection.

The search results are transmitted to the client device 106 in a form that may be presented to the user. For example, the search results 108 may be transmitted by the search system 102 as a search results web page to be displayed via the browser 107 executing on the client device 106 and/or as one or more search results conveyed to a user via audio. The search results may include only the ordered collection of information or may include the ordered collection of information in combination with one or more search results based on the responsive documents identified by the document ranking engine 110. For example, the search results illustrated in FIG. 7A include an ordered collection of information 780A in combination with search results 782 that are based on the responsive documents identified by the document ranking engine 110.

FIG. 9 is a block diagram of an example computer system 910. Computer system 910 typically includes at least one processor 914 which communicates with a number of peripheral devices via bus subsystem 912. These peripheral devices may include a storage subsystem 924, including, for example, a memory subsystem 925 and a file storage subsystem 926, user interface input devices 922, user interface output devices 920, and a network interface subsystem 916. The input and output devices allow user interaction with computer system 910. Network interface subsystem 916 provides an interface to outside networks and is coupled to corresponding interface devices in other computer systems.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices (e.g., a speaker that provides voice output). In general, use of the term “output device” is intended to include all possible types of devices and ways to output information from computer system 910 to the user or to another machine or computer system.

Storage subsystem 924 stores programming and data constructs that provide the functionality of some or all of the modules described herein. For example, the storage subsystem 924 may include the logic to perform one or more of the methods described herein such as, for example, the methods of FIGS. 5 and/or 8.

These software modules are generally executed by processor 914 alone or in combination with other processors. Memory 925 used in the storage subsystem can include a number of memories including a main random access memory (RAM) 930 for storage of instructions and data during program execution and a read only memory (ROM) 932 in which fixed instructions are stored. A file storage subsystem 924 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 924 in the storage subsystem 924, or in other machines accessible by the processor(s) 914.

Bus subsystem 912 provides a mechanism for letting the various components and subsystems of computer system 910 communicate with each other as intended. Although bus subsystem 912 is shown schematically as a single bus, alternative implementations of the bus subsystem may use multiple busses.

Computer system 910 can be of varying types including a workstation, server, computing cluster, blade server, server farm, or any other data processing system or computing device. Due to the ever-changing nature of computers and networks, the description of computer system 910 depicted in FIG. 9 is intended only as a specific example for purposes of illustrating some implementations. Many other configurations of computer system 910 are possible having more or fewer components than the computer system depicted in FIG. 9.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer implemented method, comprising:
receiving, by a search system from a client device, a search query including search query terms;
identifying documents responsive to the search query terms, the identified documents including a given webpage, wherein the given webpage includes a table with table content, and wherein the given webpage includes additional content that is external to the table;
ranking the identified documents for the search query, wherein ranking the identified documents comprises ranking the given webpage, relative to other of the documents, based on comparing one or more of the search query terms to the additional content that is external to the table;
based on the ranking for the given webpage being one of a threshold quantity of the highest ranked documents, determining a relevance score for the table of the given webpage, wherein determining the relevance score for the table is based on comparing one or more of the search query terms to the table content of the table of the given webpage;
determining to provide, in response to the search query, an ordered collection of information that is based on the table content of the table of the given webpage, wherein determining to provide the ordered collection of information is based on:
the relevance score for the table, and
the ranking of the given webpage for the search query indicating that the given webpage is one of the threshold quantity of the highest ranked documents, of the identified documents, for the search query, wherein the threshold quantity is ten, or less than ten; and
providing, from the search system to the client device, the ordered collection of information and search results for a plurality of the documents, for presentation of the ordered collection of information and the search results in response to the search query,
wherein providing the ordered collection of information and the search results comprises providing the ordered collection of information for presentation more prominently than the search results, and
wherein the table of the given webpage includes a plurality of columns and a plurality of rows, and wherein the ordered collection of information provided for presentation includes only a subset of the columns and a subset of the rows.

2-3. (canceled)

4. The method of claim 1, further comprising:
identifying a term of the search query terms;
wherein determining the relevance score includes matching the term to a superlative associated with the ordered collection of information, the superlative indicating a type of ranking of the table.

5. The method of claim 1, further comprising:
identifying a term of the search query terms;
wherein determining the relevance score includes matching the term to a subject associated with the ordered collection of information, the subject indicating an entity type of the table.

6. The method of claim 1, wherein determining the relevance score for the table based on comparing one or more of the search query terms to the table content of the given webpage comprises:
determining a relationship between one or more of the search query terms and a subject associated with the table of the given webpage, the subject indicating an entity type of the table, and
determining a relationship between one or more of the search query terms and an attribute associated with table of the given webpage, the attribute indicating a measure by which the subject is ranked in the table.

7. (canceled)

8. The method of claim 1, wherein the table of the given webpage includes the plurality of rows in an order and wherein determining to provide the ordered collection of information includes:
changing the order of the content of one or more of the rows in the ordered collection of information based on the one or more of the rows including a modifier that matches one or more of the search query terms.

9. The method of claim 1, further comprising:
identifying a modifier of a subject based on one or more of the search query terms, the modifier indicating a constraint on the subject;
wherein determining to provide the ordered collection of information includes selecting the content of only a subset of the rows based on the modifier.

10. The method of claim 1, wherein determining to provide the ordered collection of information includes:
accessing a table information index that includes a plurality of entries; and
identifying the ordered collection of information based on a document identifier of a given entry of the entries, the document identifier identifying the given webpage.

11-14. (canceled)

15. The method of claim 1, further comprising:
identifying the search query is a superlative query;
wherein determining the relevance score is further based on identifying the search query is a superlative query.

16. (canceled)

17. A computer implemented method, comprising:
identifying, utilizing one or more processors, table content of a table in a webpage, wherein the webpage includes additional content that is external to the table;
determining, based on the table content and utilizing one or more of the processors, the table includes an ordered collection;
determining, utilizing one or more of the processors, at least one subject of the table, the subject indicating an entity type of entities of the table;
determining, utilizing one or more of the processors, at least one attribute of the table, the attribute indicating a measure by which the entities are sorted or ranked in the table, and wherein determining the attribute is based on the additional content, of the webpage, that is external to the table;
associating, utilizing one or more of the processors, the subject and the attribute with an identifier of the webpage;
indicating, utilizing one or more of the processors, the webpage includes a table with the ordered collection;
subsequent to the associating and the indicating:
receiving, by a search system and from a client device, a search query including search query terms;
identifying the webpage is responsive to the search query and is one of a threshold quantity of the highest ranked documents for the search query, wherein the threshold quantity is ten, or less than ten;
based on the webpage being responsive to the search query and based on the webpage being one of the threshold quantity of the highest ranked documents for the search query:
identifying the subject and the attribute based on the association of the identifier of the webpage to the subject and the attribute;
matching one or more of the search query terms to the subject and to the attribute;
determining, based on the matching, the ordered collection of information that reflects at least some of the content of the table;
determining, based on the matching, a relevance score for the ordered collection of information;
providing, from the search system and to the client device, based on the relevance score, the ordered collection of information to the client device for presentation in response to the search query, and
wherein the table content of the table in the webpage includes a plurality of columns and a plurality of rows, and wherein the ordered collection of information provided for presentation includes only a subset of the columns and a subset of the rows.

18. (canceled)

19. The method of claim 17, wherein the additional content includes a title of the webpage.

20-22. (canceled)

23. The method of claim 17 wherein providing the ordered collection of information in response to the search query is based at least in part on the relevance score satisfying a threshold.

24. A system including memory and one or more processors operable to execute instructions stored in the memory, comprising instructions to:
receive, by a search system from a client device, a search query including search query terms;
identify documents responsive to the search query terms, the identified documents including a given webpage, wherein the given webpage includes a table with table content, and wherein the given webpage includes additional content that is external to the table;
rank the identified documents for the search query, wherein the instructions to rank the identified documents comprise instructions to rank the given webpage, relative to other of the documents, based on comparison of one or more of the search query terms to the table content of the table of the given webpage;
based on the rank for the given webpage being one of a threshold quantity of the highest ranked documents, determine a relevance score for the table of the given webpage, wherein the instructions to determine the relevance score for the table comprise instructions to determine the relevance score based on comparison of one or more of the search query terms to the table content of the table of the given webpage;
determine to provide, in response to the search query, an ordered collection of information that is based on the table content of the table of the given webpage, wherein the instructions to determine to provide the ordered collection of information comprise instructions to determine to provide the ordered collection of information based on:
the relevance score for the table, and
the rank of the given webpage for the search query indicating that the given webpage is the highest ranked, of the identified documents, for the search query; and
provide, from the search system to the client device, the ordered collection of information and search results for a plurality of the documents, for presentation of the ordered collection of information and the search results in response to the search query,
wherein providing the ordered collection of information and the search results comprises providing the ordered collection of information for presentation more prominently than the search results, and
wherein the table of the given webpage includes a plurality of columns and a plurality of rows, and wherein the ordered collection of information provided for presentation includes only a subset of the columns and a subset of the rows.

25. The method of claim 1, further comprising:
providing, to the client device for presentation in combination with the ordered collection of information, a link to the given webpage.

26. (canceled)

27. The method of claim 1, further comprising:
determining, based on one or more terms of the search query, that the search query is a superlative search query; and
wherein determining to provide the ordered collection of information is further based on determining that the search query is a superlative search query.
